(19) United States
(12) Patent Application Publication
(10) Pub. No.: US 2012/0297536 A1
(43) Pub. Date: Nov. 29, 2012

(54) Occupant Assist Assembly

(76) Inventor: Edward John Koors, Indianapolis, IN (US)

(21) Appl. No.: 13/114,492

(22) Filed: May 24, 2011

(51) Int. Cl. A61G 7/10

(52) U.S. Cl. 5/87.1

(57) ABSTRACT

An occupant assist assembly (38) for an occupant of a bed includes a pair of substantially vertically extending stanchions (44) laterally spaced apart by a prescribed clearance C. A lower portion (44A) of the pair of stanchions is configured to be connected to a person-support apparatus (10). A longitudinally extending support arm (72) is connected to an upper portion (44B) of the assist assembly. The clearance space C between the stanchions provides easy access to a bed occupant for a caregiver positioned at the head end of the bed and also provides an unobstructed line of sight when an attendant moves the bed from place to place.

### BACKGROUND

This disclosure relates to an assist assembly for an occupant of a bed and more particularly to an assist assembly that facilitates caregiver access to the occupant from the head end of the bed and that provides a substantially unobstructed line of sight past the foot end of the bed for a person standing near the head end of the bed.

Occupants of a bed, particularly occupants of a hospital bed, may find it beneficial to use various types of assistance devices during activities such as ingress into the bed, egress out of the bed, and position adjustment within the confines of the bed. Such assistance devices are attached to a support structure. Conventional support structures are anchored to the base frame of the bed so that they are laterally aligned with the longitudinally extending bed centerline. A conventional support structure extends vertically from its anchorage and then footwardly at an elevation substantially higher than that of the bed occupant. The presence of the support structure impedes caregiver access to the headboard of the bed and to the occupant when the caregiver is positioned at the head end of the bed. In addition, the support structure blocks the line of sight past the foot end of the bed for a caregiver positioned at the head end of the bed. The obstructed line of sight makes it difficult for a caregiver positioned near the head end of the bed to maneuver the bed when moving it from place to place.

### SUMMARY OF THE DISCLOSURE

An occupant assist assembly for an occupant of a bed comprises a pair of substantially vertically extending stanchions laterally spaced apart by a prescribed clearance and in which a lower portion of the pair of stanchions is configured to be connected to a person-support apparatus. A longitudinally extending support arm is connected to an upper portion of the assist assembly.

### BRIEF DESCRIPTION OF THE DRAWINGS

Referring now to the illustrative examples in the drawings, wherein like numerals represent the same or similar elements throughout:

FIG. 1 is a perspective view showing a dual-stanchion assist assembly attached to the head end of a person-support apparatus;

FIG. 2 is a perspective view similar to FIG. 1 showing the assist assembly detached from the person-support apparatus;

FIG. 3 is a right side elevation view of the assist assembly attached to the person-support apparatus;

FIG. 4 is a perspective view of the assist assembly with a support arm detached from the assist assembly;

FIG. 5 is a right side elevation view of the assist assembly.

FIG. 6 is an end elevation view of the assist assembly taken in the direction 6-6 of FIG. 5;

FIG. 7 is a plan view of the assist assembly.

FIG. 8 is a schematic, front elevation view of a 99th percentile male member of a selected population.

FIG. 9 is a schematic, front elevation view of a 1st percentile female member of a selected population.

### DETAILED DESCRIPTION

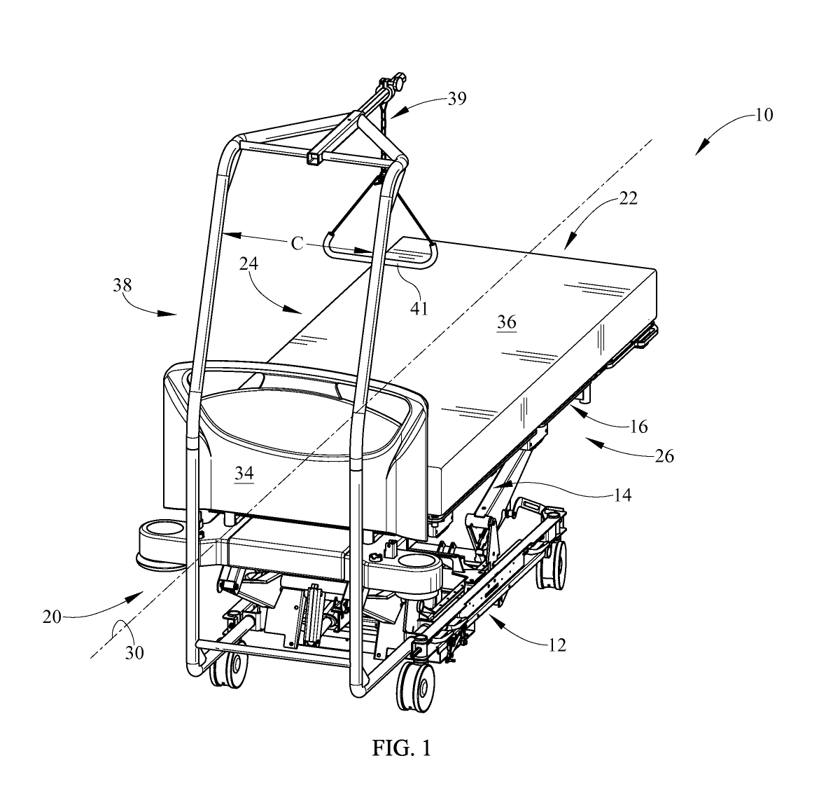

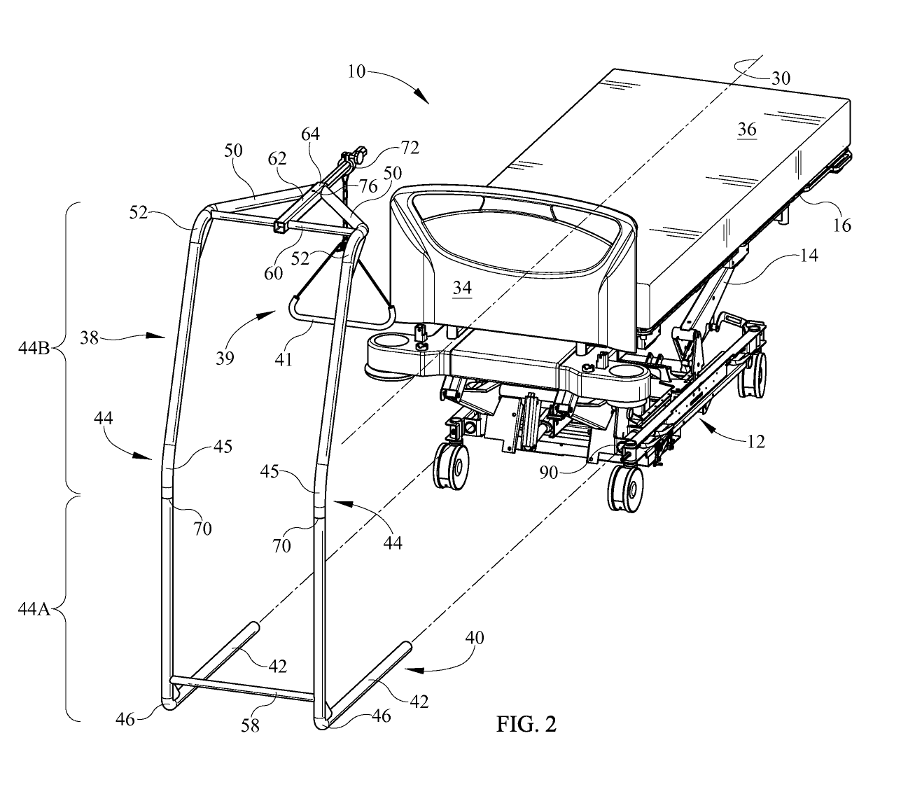

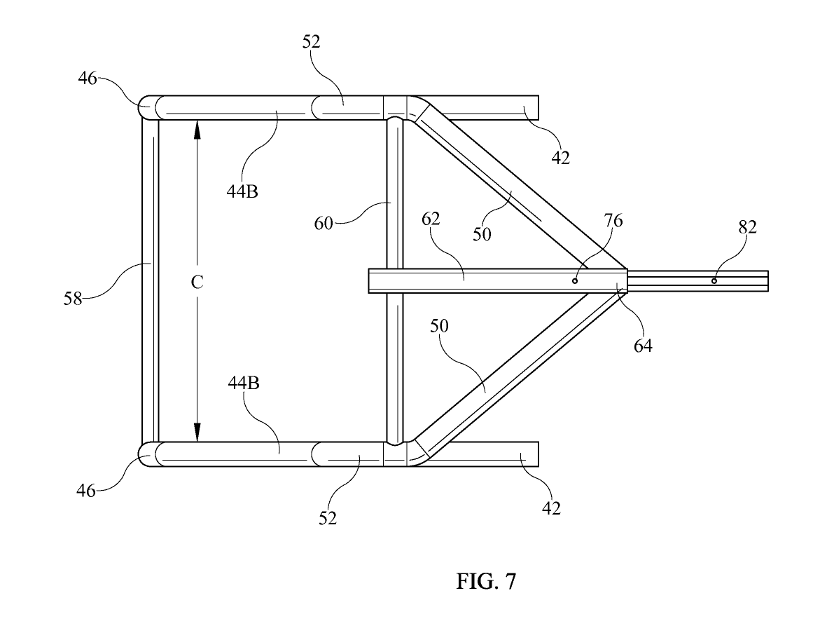

Referring to FIGS. 1-7 a person-support apparatus 10 such as a hospital bed includes a lower or base frame 12, a plurality of supports links 14 coupled to the lower frame 12, and an upper frame 16 supported on the plurality of support links 14 above the lower frame 12. The illustrated support links 14 are elements of a lift mechanism enabling the elevation of the upper frame to be changed with respect to the elevation of the lower frame. The bed extends longitudinally from a head end 20 to a foot end 22 and laterally from a left side 24 to a right side 26. Selected illustrations also show a longitudinally extending centerline 30.

The bed 10 also includes a deck (not visible) supported on the upper frame, a plurality of siderails (not shown) a headboard 34, a footboard (not shown) and a mattress 36.

The illustrations also show an occupant assist assembly 38. The occupant assist assembly 38 is designed to offer support to a person trying to enter or exit the bed and to adjust his or her position on the bed. An attachment in the form of a sturdy metal triangle 39, also referred to as a “trapeze”, can be attached to the assist assembly as shown. In practice the occupant grasps the base 41 of the triangle to assist with ingress, egress or repositioning.

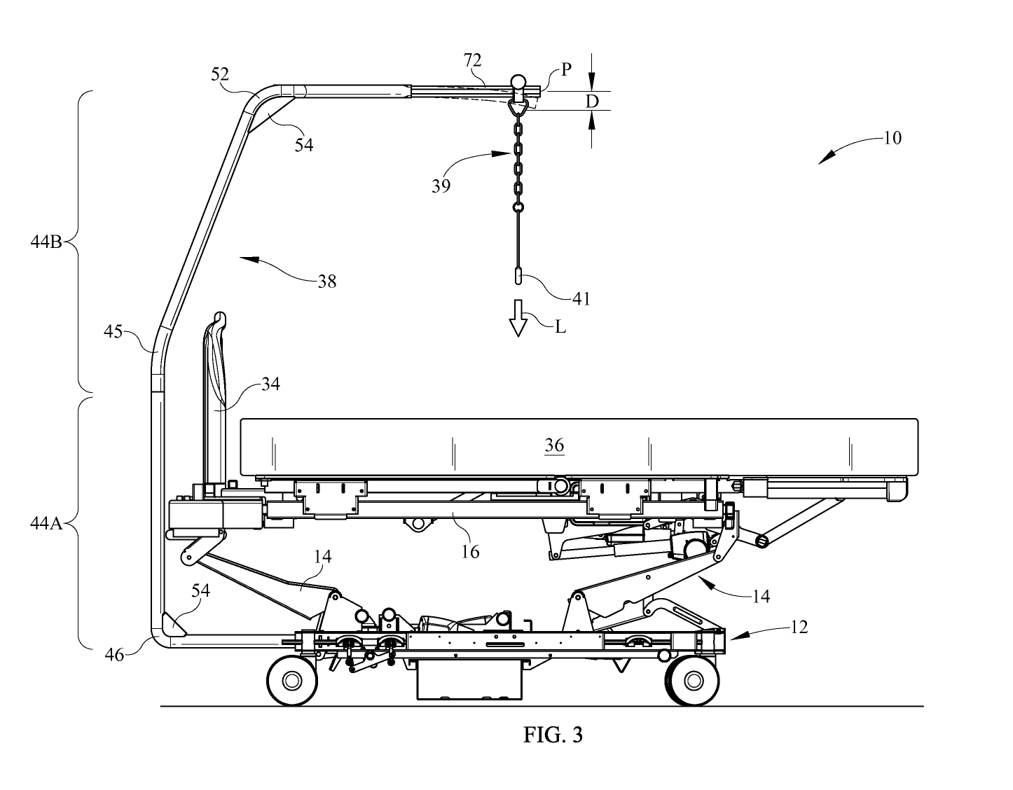

The assist assembly 38 is a dual-stanchion arrangement The assist assembly includes an adaptor 40 comprising a pair of horizontal base rods 42, and a pair of substantially vertically extending stanchions 44 connected to the adaptor rods at respective lower elbows 46. The stanchions are laterally spaced from each other by a prescribed clearance C. Each stanchion has a lower portion 44A and an upper portion 44B connected to the lower portion by a connector 45. Connector 45 subtends an arc α of about 22 degrees relative to vertical so that upper portion 44B is oriented off-vertical by about 22 degrees. Oblique braces 50 are each connected to the stanchions at respective upper compound elbows 52. Gussets 54, seen best in FIGS. 3-5, span across each elbow. The oblique braces 50 converge toward each other as they extend toward the foot end 22 of the bed. The assist assembly also includes lower and upper stiffening braces 58, 60 extending laterally between the stanchions at or near elbows 46, 52 respectively. The braces 58, 60 help to stiffen the structure and ensure parallelism of the stanchions. A hollow support brace 62 extends from the lateral midpoint of upper stiffening brace 60 and is joined to oblique braces 50 at a vertex 64. The materials, part geometries, joinery techniques and fabrication techniques used in the construction of the assist assembly are such that when subject to a specified vertically downwardly directed load L at a specified point P (FIG. 3), deflection D of point P is less than a specified amount. For example it might be required that deflection of P be no more than 4 inches (approximately 10 cm) for a load L of 250 pounds (approximately 114 kg).

The connections at the elbows 46, 52, between the stiffening braces 58, 60 and the stanchions 44, between the support brace 62 and the upper stiffening brace 60, and at the vertex 64 are permanent (e.g. welded or brazed) or semipermanent (e.g. bolted) connections not intended to accommodate routine disassembly. At locations subject to lower stresses, a separable connection may be provided to facilitate disassembly thereby saving space when the assist assembly is stored and transported, and rendering it less awkward when separated from the bed. An example of such a connection is connection 70 in which a larger diameter hollow upper section of each stanchion receives a smaller diameter projection (not visible) extending vertically upwardly from a lower section of the stanchion. With such a connection, the upper and lower stanchion sections can be separated from or connected to each other without the use of tools or special techniques.

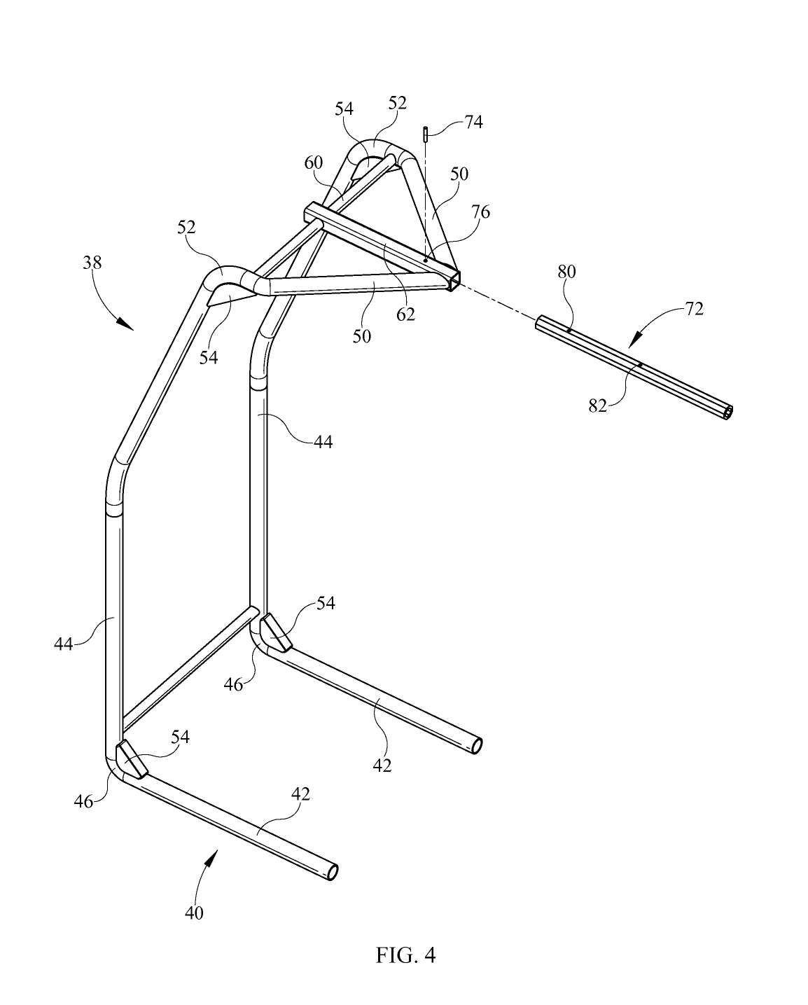

The assist assembly also includes a retractable and deployable support arm 72. The support brace 62 slidingly receives the support arm. A pin 74 (FIG. 4) extends through a hole 76 in support brace 62 and into a first opening 80 in support arm 72 to lock the support arm in a deployed position. When it is desired to retract the support arm a user removes the pin, slides the support arm headwardly into the support brace 62 until second opening 82 in the support arm registers with hole 76. The user then re-installs the pin through hole 76 and opening 82. Additional openings may be provided to allow for graduated extension and retraction. Detents may be provided to facilitate alignment of the openings with the hole.

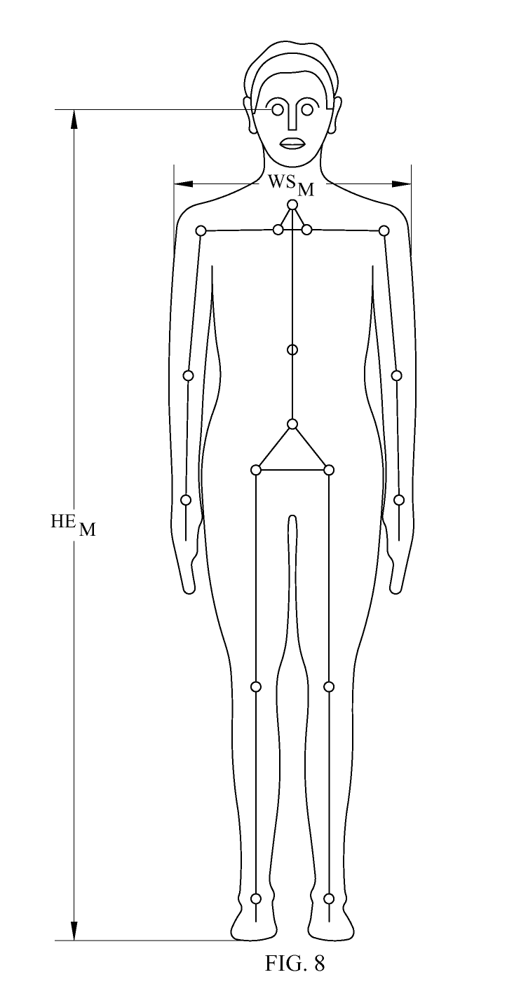

Because the assist assembly includes a pair of laterally spaced apart stanchions rather than a single stanchion aligned with centerline 30, a caregiver standing at the head end of the bed has easy access to the bed occupant. In addition, the caregiver has an unobstructed line of sight past the foot end of the bed, which is helpful when the caregiver maneuvers the bed from place to place. Referring to FIG. 8, the prescribed lateral clearance C is at least as large as the shoulder width WS_{M} of a specified percentile male member of a selected population. Such anthropometric information can be found in reference sources such as The Measure of Man & Woman, Henry Dreyfus Associates, ISBN 0-471-09955-4. For example the Dreyfus reference shows that the shoulder width of a 99 percentile male is about 20.6 inches (approximately 52 cm). In other words, only a small fraction of the population used to establish the 20.6 inch male shoulder width has a larger shoulder width, and not even all of the members of the excluded subset of the male population will necessarily experience undue difficulty. An example population, which is not necessarily the population represented in the reference, is United States males in the age range of 25-64 years.

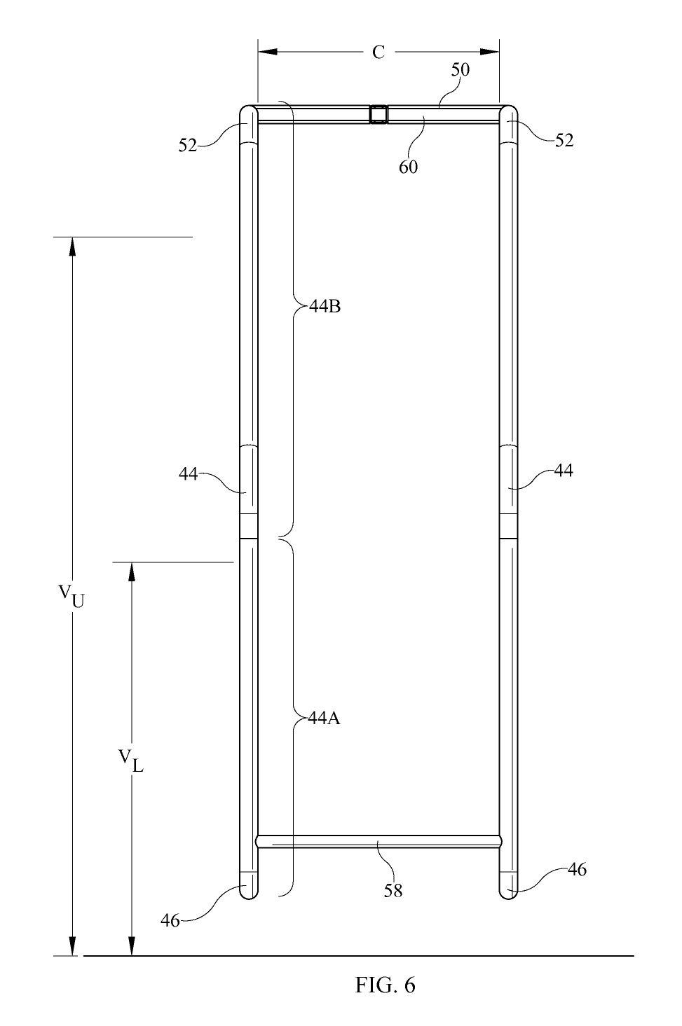

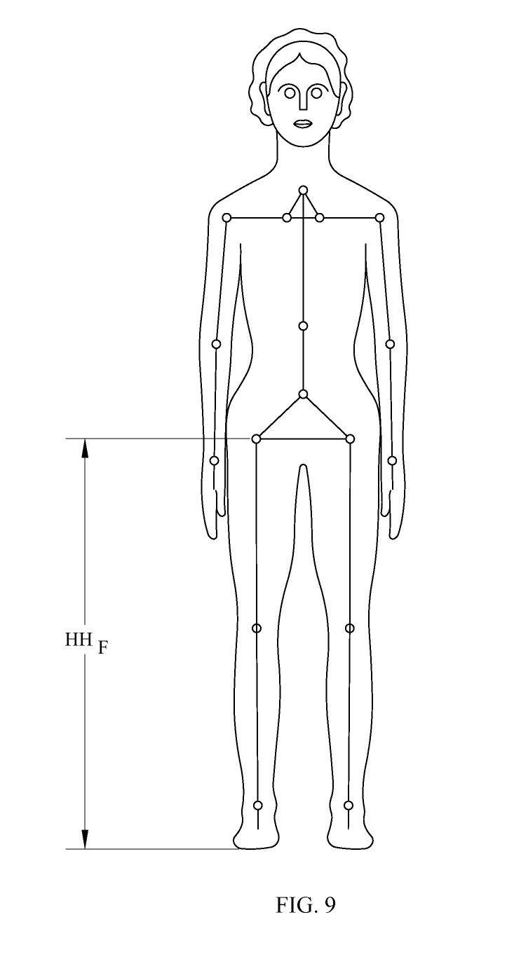

The prescribed shoulder clearance must be present across a range of heights sufficient to accommodate a range of caregivers, i.e. to allow those caregivers to reach through the clearance space C defined by the stanchions to attend to a bed occupant and to enjoy an unobstructed line of sight between the stanchions. Accordingly, the prescribed clearance is present in a vertical range extending from a vertical lower limit V_{L} to a vertical upper limit V_{U} (FIG. 6). Referring additionally to FIG. 9, an example lower limit V_{L} is a height no higher than the hip height HH_{F} of a specified percentile female member of a selected population. For example the Dreyfus reference shows that the hip height of 1 percentile female is about 29.6 inches (approximately 75 cm). In other words, only a small fraction of the population used to establish the 29.6 inch female hip height will be short enough to be unable to comfortably take advantage of the inter-stanchion clearance C, and not even all of the members of the short subset of the female population will necessarily experience undue difficulty. An example population, which is not necessarily the population represented in the reference, is United States females in the age range of 25-64 years. An example upper limit V_{U} is a height no lower than the eye height HE_{M} of a specified percentile member of a selected male population. For example the Dreyfus reference shows that the eye height of 99 percentile male is about 70.8 inches (approximately 180 cm). In other words, only a small fraction of the population used to establish the 70.8 inch male eye height will be too tall to benefit from the unobstructed line of sight afforded by the laterally paced apart stanchions. By using these or similar guidelines, the clearance will comfortably accommodate all but a small fraction of caregivers who need to reach through the stanchions to attend to a bed occupant and/or to see through the clearance space to move the bed from place to place. The clearance space can be a substantially constant width throughout the range of heights bounded by the upper and lower limits or can be a varying clearance. The populations used to define the shoulder clearance and the upper and lower range of heights across which the clearance must be present need not be the same populations.

When in use, receptacles 90 in the base frame of the bed receive adaptor rods 42. Typically the connection between the assist assembly adaptor rods and the base frame would be secured by a retainer such as a pin extending through registered openings in each receptacle and into corresponding openings in the associated adaptor rod.

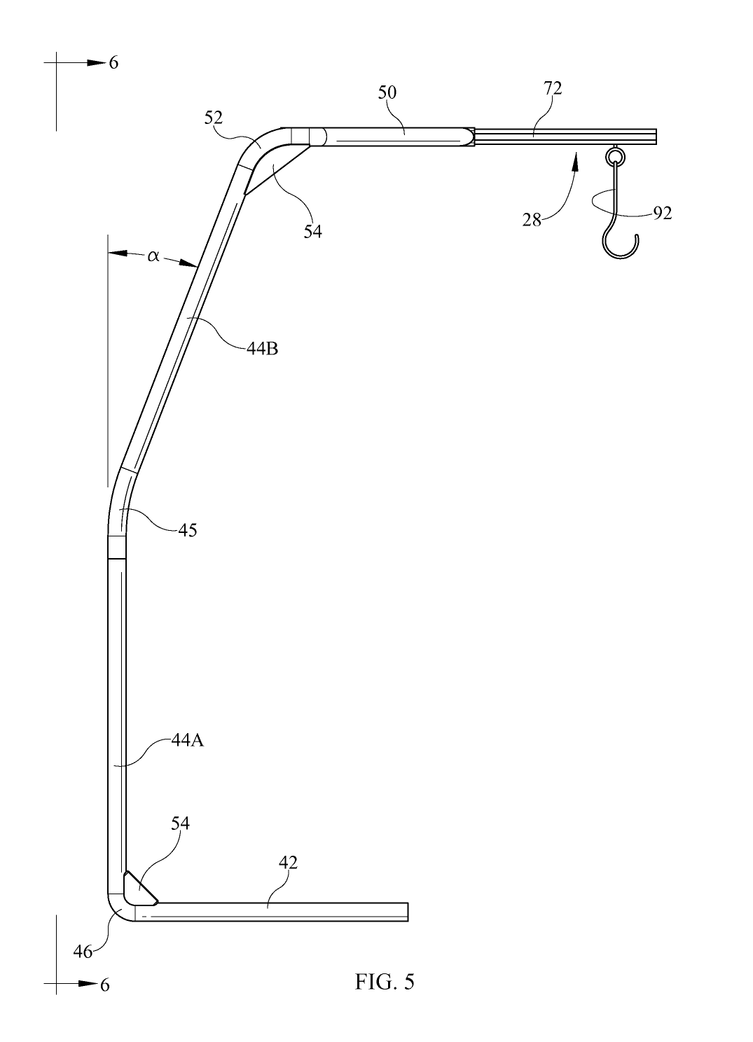

The support arm 72 can also be used to suspend a hook 92 as seen in FIG. 5 of the type used to hang the intravenous (IV) fluid bottle or to suspend or support other accessories.

In reading the claims it is intended that when words such as “a,” “an,” “at least one,” “at least a portion” are used there is no intention to limit the claim to only one item unless specifically stated to the contrary in the claim. When the language “at least a portion” and/or “a portion” is used the item can include a portion and/or the entire item unless specifically stated to the contrary.

I claim:

1. (canceled)

2. An occupant assist assembly for an occupant of a bed comprising:
a pair of substantially vertically extending stanchions laterally spaced apart by a prescribed clearance which is at least as large as the shoulder width of a specified percentile male member of a selected population, a lower portion of the pair of stanchions being configured to be connected to a person-support apparatus; and
a longitudinally extending support arm connected to an upper portion of the assist assembly.

3. The occupant assist assembly of claim 2 wherein the prescribed clearance is present in a vertical range extending from a vertical lower limit which is no higher than the hip height of a specified percentile female member of a selected population to a vertical upper limit no lower than the eye height of a specified percentile male member of a selected population.

4. The occupant assist assembly of claim 3 wherein the specified percentile for the female member of the selected population is 1%, the selected female population is United States females in the age range of 20 to 64 years, the specified percentile for the male member of the selected population is 99%, and the selected male population is United States males in the age range of 20 to 64 years.

5. The occupant assist assembly of claim 2, wherein lower and upper stiffening braces extend laterally between the stanchions.

6. The occupant assist assembly of claim 2, wherein the support arm extends from a support brace.

7. The occupant assist assembly of claim 2 wherein each stanchion includes a lower section and an upper section connected to the lower portion by a separable connection.

8. The occupant assist assembly of claim 2 where the prescribed clearance is a substantially constant clearance throughout a range of heights.
